(19) United States
(12) Patent Application Publication
(10) Pub. No.: US 2007/0159438 A1
(43) Pub. Date: Jul. 12, 2007

(54) DRIVING APPARATUS AND LIQUID CRYSTAL DISPLAY INCLUDING THE SAME

(76) Inventor: Kang-yeon CHO, Suwon-si (KR)

Correspondence Address: F. CHAU & ASSOCIATES, LLC, 130 WOODBURY ROAD, WOODBURY, NY, 11797, US

(21) Appl. No.: 11/562,112

(22) Filed: Nov. 21, 2006

(30) Foreign Application Priority Data
Dec. 29, 2005 (KR) 10-2005-0133952

(51) Int. Cl. G09G 3/36

(52) U.S. Cl. 345/98

(57) ABSTRACT

A driving apparatus that can easily detect a failure occurring in a liquid crystal panel and a liquid crystal display comprising the driving apparatus for a display comprises a voltage generator generating first and second gate clock signals that are a combination of a gate-on signal and a gate-off signal, wherein the first and second gate clock signals control a turn-on/off condition of a gate line, and a signal comparator comparing the first gate clock signal and the second gate clock signal with each other and turning a timing controller for the display on or off according to a comparison result.

### CROSS REFERENCE TO RELATED APPLICATION

This application claims priority from Korean Patent Application No. 10-2005-0133952 filed on Dec. 29, 2005 in the Korean Intellectual Property Office, the disclosure of which is incorporated herein by reference in its entirety.

### BACKGROUND OF THE INVENTION

1. Technical Field

The present disclosure relates to a driving apparatus and a liquid crystal display including the same and, more particularly, to a driving apparatus that can easily detect a failure occurring in a liquid crystal panel and a liquid crystal display including the same.

2. Discussion of the Related Art

Liquid crystal displays (LCDs) are a type of flat panel display that offers low power consumption, slim and lightweight design, and low driving voltage.

An LCD includes a color filter display panel having reference electrodes and color filters, a thin transistor (TFT) substrate having TFTs and pixel electrodes, and a liquid crystal layer sandwiched between the color filter display panel and the first display plate. In the LCD, an electric field is created by applying different electric potentials to a pixel electrode and a reference electrode, respectively, and the electric field alters the alignment of the liquid crystal molecules to control the transmittance of light. In this way, the LCD displays an image.

In such an LCD, amorphous or polycrystalline silicon is used as the thin film transistor material. An LCD using TFTs made of polysilicon (poly-Si), which exhibits high electron mobility, is easily integrated into a glass substrate. Nevertheless, since an LCD using TFTs made of amorphous silicon (a-Si) exhibits low electron mobility, the a-Si TFT-LCD is constructed of pixels provided on a liquid crystal panel, and the driving chips are separately manufactured and connected to the pixels of the liquid crystal panel.

For color representation of an XGA (Extended Graphics Array) resolution, for example, it is necessary to drive 1024*3*768 subpixels. Thus, eight data driving chips for 384 channels and three gate driving chips for 256 channels may be used. An alternative way to drive 1024*3*768 subpixels is to use four data driving chips for 384 channels and six gate driving chips for 256 channels. In the latter case, since a gate line pitch is approximately three times a data line pitch, the gate driving chips cannot be loaded on one side of a gate-driving unit, so that a dual-gate driving method is employed, in which gate drivers are loaded on both sides of the gate-driving unit.

In this case, when the liquid crystal panel does not operate normally due to a failure occurring in a portion of one side of the liquid crystal panel, it is quite difficult to detect the failure. That is to say, in dual-gate driving, in which gate driving ICs are arranged at opposite sides of the liquid crystal panel, even if some lines of one side of the liquid crystal panel fail, it may not be easily perceived by the user. Once failures occur in one block of the liquid crystal panel, the other block of the liquid is vulnerable to degradation, which lowers the reliability of the liquid crystal panel.

### SUMMARY OF THE INVENTION

Exemplary embodiments of the present invention provide a driving apparatus that can easily detect a failure occurring in a liquid crystal panel.

Exemplary embodiments of the present invention provide a liquid crystal display including a driving apparatus that can easily detect a failure occurring in a liquid crystal panel.

According to an exemplary embodiment of the present invention, there is provided a driving for a display comprising apparatus including a voltage generator generating first and second gate clock signals that are a combination of a gate-one signal and a gate-off signal, wherein the first and second gate clock signals control a turn-on/off condition of a gate line, and a signal comparator comparing the first gate clock signal and the second gate clock signal with each other and turning a timing controller for the display on or off according to a comparison result.

According to an exemplary embodiment of the present invention, there is provided a driving apparatus for a display comprising a voltage generator generating first and second gate clock signals that are a combination of a gate-one signal and a gate-off signal, wherein the first and second gate clock signals control a turn-on/off condition of a gate line, and a signal comparator including a first amplifier amplifying and outputting a difference between the first gate clock signal and the second gate clock signal, a second amplifier amplifying and outputting a difference between an output signal of the first amplifier and the gate-off signal, and a third amplifier amplifying and outputting a difference between an output signal of the first amplifier and a driving voltage.

According to an exemplary embodiment of the present invention, there is provided a liquid crystal display comprising a liquid crystal panel including a plurality of unit pixels having a respective plurality of switching devices arranged in a matrix, a plurality of gate lines and data lines connected to the plurality of switching devices and transmitting data and gate voltages, the gate lines extending to sides of the liquid crystal panel, and first and second gate drivers connected to the plurality of gate lines at both sides of the liquid crystal panel to which the plurality of gate line extend, a timing controller receiving externally supplied image data from an external device and outputting data suitable for operating conditions of the liquid crystal panel and generating gate and data control signals for driving the first and second gate drivers and a data driver, an voltage generator generating first and second gate clock signals that are a combination of a gate-on signal and a gate-off signal, wherein the first and second gate clock signals control a turn-on/off condition of a gate line and a signal comparator comparing the first gate clock signal and the second gate clock signal with each other, providing the first gate clock signal and the second gate clock to the first and second gate drivers, respectively, of the first gate clock signal and the second gate clock are the same, and turning off the timing controller if the first gate clock signal and the second gate clock signal are not the same, and the data driver applies a data voltage to the plurality of data lines.

### BRIEF DESCRIPTION OF THE DRAWINGS

Exemplary embodiments of the present invention will be understood in more detail from the following description taken in conjunction with the attached drawings in which

FIG. 1 is a block diagram of a liquid crystal display (LCD) according to an exemplary embodiment of the present invention;

FIG. 2 is an equivalent circuit diagram of a pixel in an LCD according to an exemplary embodiment of the present invention;

FIG. 3 is a block diagram of a gate driving circuit according to an exemplary embodiment of the present invention.

FIG. 4 is an equivalent circuit diagram of a shift register used in the circuit shown in FIG. 3;

FIG. 5 is an internal block diagram of a signal comparator according to an exemplary embodiment of the present invention; and

FIG. 6 is a flow chart showing an operation of the signal comparator according to an exemplary embodiment of the present invention.

### DETAILED DESCRIPTION OF EXEMPLARY EMBODIMENTS

Advantages and features of the present invention and methods of accomplishing the same may be understood more readily be reference to the following detailed description of exemplary embodiments and the accompanying drawings. Like reference numerals refer to like elements throughout the specification.

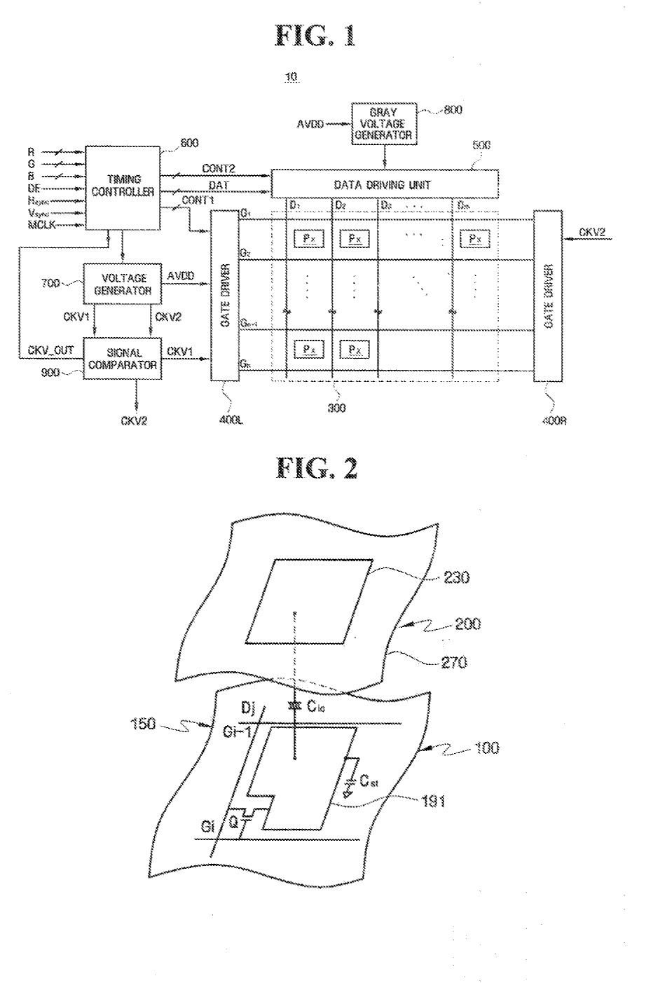

FIG. 1 is a block diagram of a liquid crystal display (LCD) 10 according to an exemplary embodiment of the present invention, and FIG. 2 is an equivalent circuit diagram of a pixel of the LCD according to an exemplary embodiment of the present invention.

Referring to FIG. 1, the LCD 10 includes a liquid crystal display panel 300, gate drivers 400L and 400R connected to the display panel 300, a data driving unit 500, a gray voltage generator 800 connected to the data driving unit 500, a timing controller 600 controlling these elements, a voltage generator 700, and a signal comparator 900.

In LCD 10 shown in FIG. 1, the liquid crystal panel 300 includes a plurality of unit pixels including a plurality of display signal lines G1-Gn and D1-Dm formed of a plurality of gate lines G1-Gn and a plurality of data lines D1-Dm connected thereto, and arranged substantially in a matrix.

The display signal lines G1-Gn and D1-Dm include the plurality of gate lines G1-Gn transmitting gate signals and the plurality of data lines D1-Dm transmitting data signals. The gate lines G1-Gn extend substantially in a row direction and are substantially parallel to each other, while the data lines D1-Dm extend substantially in a column direction and are substantially parallel to each other.

As shown in FIG. 2, each of the plurality of pixels consists of a switching device Q connected to a corresponding one of the plurality of display signal lines G1-Gn and D1-Dm, a liquid crystal capacitor C_{lc} and a storage capacitor Cₛₜ connected to the switching device Q. The storage capacitor C_{Sst} may not be necessary.

The switching device Q is formed on a first display plate 100. The switching device Q is a three-terminal device consisting of a control terminal connected to the corresponding one of the plurality of gate line G1-Gn, an input terminal connected to the corresponding one of the plurality of data lines D1-Dm, and an output terminal connected to the liquid crystal capacitor C_{lc} and the storage capacitor Cₛₜ.

The liquid crystal capacitor C_{lc} includes a pixel electrode 191 provided on the first display plate 100 and a common electrode 270 provided on a second display plate 200 forming the two terminals of the capacitor. The liquid crystal layer 150 disposed between the two electrode 191 and 270 functions as a dielectric of the liquid crystal capacitor C_{lc}. The pixel electrode 191 is connected to the switching device Q and the common electrode 270 is connected to the common voltage Vcom and covers the entire surface of the second display plate 200. Unlike what is shown in FIG. 2, the common electrode 270 may be provide on the first display plate 100, and both electrodes 191 and 270 may have bar or stripe shapes.

The storage capacitor Cₛₜ is defined by the overlap of the pixel electrode 191 and a separate wire (not shown) provided on the first display plate 100 and applied with a predetermined voltage, such as the common voltage Vcom, and which is known as the separate wire type. Otherwise, the storage capacitor Cₛₜ is defined by the overlap of the pixel electrode 191 and its previous gate line via an insulator, which is known as the previous gate type.

Meanwhile, each pixel can represent color in order to display a color image. To this end, a red (R), green (G), or blue (B) color filter 230 may be disposed on a region on the second display plate 200 corresponding to the pixel electrode 191, as shown in FIG. 2. Unlike what is shown in FIG. 2, however, the red (R), green (G), or blue (B) color filter 230 may be disposed above or below the pixel electrode on the first display pate 100.

A polarizer or polarizers (not shown) attached to at least one of the first display plate 100 and the second display plate 200 of the liquid crystal panel 300 convert light polarization into light transmittance.

The gray voltage generator 800 generates two sets of pluralities of gray voltages related to the transmittance of the pixels. The gray voltages in one set have a positive polarity with respect to the common voltage Vcom, while those in the other set have a negative polarity with respect to the common voltage Vcom. The positive-polarity gray voltages and negative-polarity gray voltages are alternately supplied to the liquid crystal panel 300.

The gate drivers 400L and 400R are disposed at left and right sides of the liquid crystal panel 300, respectively, and are connected to the plurality of gate lines G1-Gn of the liquid crystal panel 300. The gate drivers 400L and 400R apply gate clock signals that are a combination of the gate-on voltage Von and the gate-off voltage Voff to the gate lines G1-Gn.

The data driving unit 500 is connected to the plurality of data lines D1-Dm of the liquid crystal panel 300 and typically includes a plurality of integrated circuits (ICs). The data driving unit 500 generates gray voltages based on a plurality of voltages supplied from the gray voltage generator 800, selects the generated gray voltages, and applies the gray voltages to each pixel as data signals.

The timing controller 600 generates control signals for controlling operations of the gate drivers 400L and 400R and data driving unit 500 and provides the corresponding control signals to the gate drives 400L and 400R and the data driving unit 500, respectively.

The voltage generator 700 generates a plurality of driving signals. For example, a driving voltage generator (not shown) generates first and second gate clock signals CKV1 and CKV2 and a common voltage Vcom. When the first and second gate clock signals CKV1 and CKV2 are at logic high level, they are gate-on signals. When the first and second gate clock signals CKV1 and CKV2 are at logic low level, they are gate-off signals.

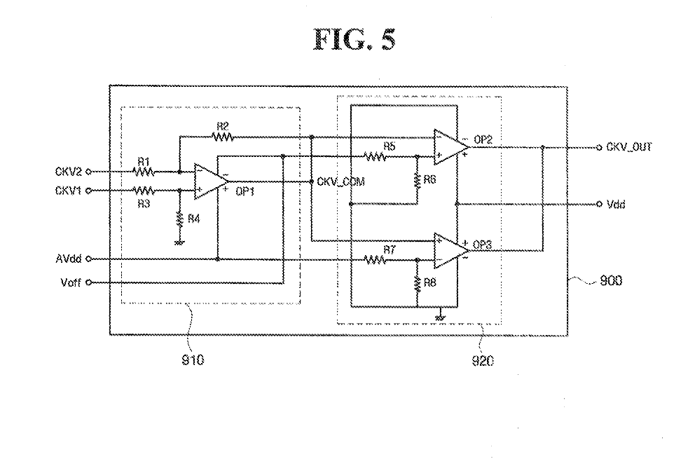

The signal comparator 900 compares first and second gate clock signals CKV1 and CKV2 applied from the voltage generator 700. Based on the result, the timing controller 600 is operated to turn on/off, which will be described in more detail with reference in FIG. 5/

The operation of the LCD will now be described in more detail.

The timing controller 600 receives R, G, and B image signals and input control signals controlling the display of the R, G, and B image signals, such as a vertical synchronization signal V_{sync}, a horizontal synchronization signal H_{sync}, main clock MCLK and data enable signal DE, from an external graphic controller (not shown). The timing controller 600 generates a gate control signal CONT1 and a data control signal CONT2 based on the input control signal, processes the image signal R, G and B for the liquid crystal panel 300 on the basis of the input control signals. The signal controller 600 provides the gate control signals CONT1 for the gate driving circuit 400, the data control signals CONT2 and the processed image signals R′, G′ and G′ for the data driving unit 500.

The gate control signals CONT1 include a vertical synchronization start signal STV for informing of the start of a frame, a gate clock signal for controlling the output time of the gate-on voltage Von, and an output enable signal for defining the widths of the gate-on voltage Von.

The data control signals CONT2 include a horizontal synchronization start signal for informing of the start of a horizontal period, a load signal for instructing to apply the appropriate data voltages to the data lines D1-Dm, an inversion control signal for reversing the polarity of the data voltages with respect to the common voltage Vcom, and a data clock signal.

The data driving unit 500 receives a packet of the image data R′, G′ and B′ for a pixel row from the timing controller 600 in response to the data control signal CONT2 received from the timing controller 600 and coverts the image data R′, G′ and B′ into data voltages selected from the gray voltages.

Responsive to the gate control signals CONT1 from the timing controller 600, the gate drivers 400L and 400R apply the gate-on voltage Von to the gate lines G1-Gn, thereby turning on the switching devices Q connected thereto.

The data driving unit 500 applies the data voltages to the corresponding data lines D1-Dm during a turn-on time of the switching devices Q due to the application of the gate-on voltage Von to gate lines G1-Gn connected to the switching devices Q, in what is called “one horizontal period” or “1H” that equals one period of the horizontal synchronization signal H_{sync}, the data enable signal DE, and the data clock signal). Then, the data voltages in turn are supplied to the corresponding pixels via the turned-on switching devices Q.

The liquid crystal molecules have orientations depending on the variation of the electric field generated by the pixel electrode 191 and the common electrode 270, as shown in FIG. 1, and the molecular orientations determine the polarization of light passing through the liquid crystal layer 150. A change in polarization results in a change in the amount of transmittance of light passing through a polarizer or polarizers (not shown) attached to at least one of the first and second display substances 100 and 200 that convert the light polarization into the light transmittance.

By repeating this procedure, all gate lines G1-Gn are sequentially supplied with the gate-on voltage Von during a frame, thereby applying the data voltages to all pixels. When the next frame starts finishing one frame, the inversion control signal applied to the data driving unit 500 is controlled such that polarity of the data voltages is reversed, which is called “frame inversion”. The inversion control signal may be also controlled such that the polarity of the data voltages flowing in a data line in one frame is reversed, which is called “line inversion”, or the polarity of the data voltages in one packet is reversed, which is called “dot inversion”.

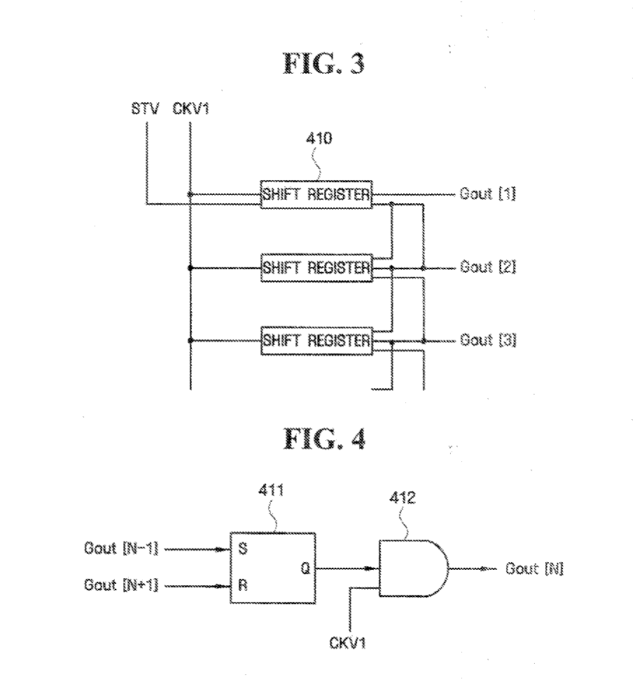

Now, the configuration and operation of a gate driver according to an exemplary embodiment of the present invention will be described in more detail with reference to FIGS. 3 and 4.

FIG. 3 is a block diagram of a gate driver according to an exemplary embodiment of the present invention, and FIG. 4 is an equivalent circuit diagram of a shift register shown in FIG. 3. For convenient explanation, the gate driver 400L shown in FIG. 1 will be described hereinafter by way of example.

As shown in FIG. 3, the gate driver includes a plurality of shift registers 410 arranged in a line. The plurality of shift registers 410 may be formed together with switching devices of pixels to be integrated on the same substrate. In other words, the plurality of shift registers 410 may be formed at the same time when forming the liquid crystal panel 300 rather than separately providing and mounting the same on a substrate prior to use.

As shown in the equivalent circuital of a shift register in FIG. 4, each of the plurality of shift registers 410 includes an SR latch 411 and an AND gate 412.

The gate driver 400L sequentially applies the gate-on voltage Von to the gate lines G1-Gn arranged in series according to a vertical synchronization start signal STV supplied from the timing controller 600 as part of the control signal CONT1 to instruct the start of outputting of a first gate clock signal CKV1.

The first shift register 410, which is synchronized with a vertical synchronization start signal STV and the first gate clock signal CKV1, starts to output the gate-on voltage Von, and the remaining shift register 410, which are synchronized with output voltages of previous-stage shift registers 410 and the first gate clock signal CKV1, also start to output the gate-on voltage Von. The operation of the shift register 410 will now be described in greater detail.

The SR latch 411 has a set input terminal S to which previous-stage gate outputs Gout [N−1], that is, output signals of previous-stage shift registers, are input, and a reset input terminal R to which next-stage gate outputs Gout [N+1], that is, output signals of next-stage shift registers, are input. The AND gate 412 receives the output of the SR latch 411 and the first gate clock signal CKV1 as its two inputs and generates gate signals Gout [N].

At an initial state where the previous-stage gate outputs Gout [N−1] and the next-stage gate outputs Gout [N+1] are all logic low (‘0’), the output of the SR latch 411 is also logic low. If the previous-stage gate output Gout [N−1] goes to high (‘1’) during a period in which the next-stage gate output Gout [N+1] maintains a low level, the output Q of the SR latch 411 makes a transition to a logic high level. However, even if the previous-stage gate output Gout [N−1] goes back to low while the next-stage gate output [N+1] is kept at a logic low level, the output Q of the SR latch 411 makes no transition. If the next-stage gate output Gout [N+1] goes high during an inactive period in which the previous-stage gate output Gout [N−1] is kept at a logic low level, the output Q of the SR latch 411 goes from high to low. The output Q of the SR latch 411 is at logic low while it maintains a logic high level from a time at which the previous-stage gate output Gout [N−1] goes from low to high until the next-stage gate output Gout [N+1 ] goes from low to high.

The AND gate 412 generates gate signals Gout [N] of logic high when the output Q of the SR latch 411 and the first gate clock signal CKV1 are both logic high, and this will now be described in detail. When the first clock signal CKV1 makes a transition from low to high in the active period in which the output Q of the SR latch 411 maintains a logic high level, the gate output Gout [N] goes high. Alternatively, when the output Q of the SR latch 411 goes low, and the first gate clock signal CKV1 goes low, the gate output Gout [N] goes low.

In this way, the respective shift registers 410 generate the gate outputs Gout [N] in synchronization with the first gate clock signal CKV1 based on the previous-stage gate outputs Gout [N−1 ] and the next-stage gate outputs Gout [N+1].

FIG. 5 is a circuit diagram of a signal comparator 900 according to an exemplary embodiment of the present invention.

The signal comparator 900 compares first and second gate clock signals CKV1 and CKV2 applied to the gate drivers 400L and 400R disposed at both sides of the liquid crystal panel 300 and outputs a comparison result to an output terminal CKV_OUT. If the first and second gate clock signals CKV1 and CKV2 applied to the signal comparator 900 are the same, a low level signal is output terminal CKV_OUT. If the first and second gate clock signals CKV1 and CKV2 applied to the signal comparator 900 are not the same, a high level signal is output to the output terminal CKV_OUT. If the output terminal CKV_OUT is connected to a terminal at which the operation of the timing controller 600 is turned off to output a high level signal to the output terminal CKV_OUT, the timing controller 600 is turned off to control that an image not be displayed on the liquid crystal panel 300.

Referring again to FIG. 5, the signal comparator 900 includes a subtractor 910 comparing a difference between the first and second gate clock signals CKV1 and CKV2 provided from the voltage generator 700, and a signal detector 920 determining whether the difference between the first and second gate clock signals CKV1 and CKV2 falls under a predetermined voltage and outputting a comparison result.

The subtractor 910 is comprised of an operating amplifier OP1 and has an inverting input terminal connected to resistors R1 and R2 and a non-inverting input terminal connected to resistors R3 and R4. The non-inverting and inverting input terminate are supplied with the first and second gate clock signals CKV 1 and CKV 2 provided from the voltage generator 700 through the resistors R1 and R3, respectively. The difference between the first and second gate clock signals CKV1 and CKV2 is amplified and output to a node CKV_COM. Here, the resistors R1 and R2 and the resistors R3 and R4 serve as voltage dividers that drip the voltage levels.

If the first and second gate clock signals CKV1 and CKV2 are the same, a voltage level of 0V is output to the node CKV_COM, suggesting that there is no difference between the voltage levels of the first and second gate clock signals CKV1 and CKV2. When the first and second clock signals CKV1 and CKV2, whose voltage levels are equal are applied to the gate drivers 400L and 400R, respectively, the liquid crystal panel operates normally. When the first and second gate clock signals CKV1 and CKV2 are not the same, however, a difference between the first and second gate clock signals CKV1 and CKV2 is amplified and output to the node CKV_COM, suggesting that there is a difference between the voltage of the first and second gate clock signals CKV1 and CKV2. When the first and second clock signals CKV1 and CKV2 whose voltage levels are different from each other are applied to the gate drivers 400L and 400R, respectively, a failure may occur to one-side of the liquid crystal panel.

The signal detector 920 is comprised of two operating amplifiers OP2 and OP3. The inverting input terminal of the operating amplifier OP2 is connected to the resistor R2 and the node CKV_COM and the non-inverting input terminal thereof is connected to resistors R5 and R6. The resistor R5 is connected to the input terminal (−) of the operating amplifier OP1 and to a gate-off voltage Voff. The input terminal (−) of the operating amplifier OP2 is connected to ground potential.

The non-inverting input terminal of the operating amplifier OP3 is connected to the node CKV_COM and the inverting input terminal thereof is connected to resistors R7 and R8. The resistor R7 is connected to a driving voltage Avdd and the input terminal (+) of the operating amplifier OP1. The input terminal (−) of the operating amplifier OP3 is also connected to ground potential. The input terminal (+) of the operating amplifiers OP2 and OP3 are connected to a power voltage Vdd. Although not shown in FIG. 5, the output terminals CKV_OUT of the operating amplifiers OP2 and OP3 are connected together and fed to the timing controller 600. The resistors R5 and R6 and the resistors R7 and R8 serve as voltage dividers that drop voltage levels.

The signals detector 920 sets reference voltages of the operating amplifiers OP2 and OP3 to predetermined levels by means of the voltage dividers. In other words, the reference voltages of the operating amplifiers OP2 and OP3 are set to a positive (+) reference voltage by means of the resistors R5 and R6 and to a negative (−) reference voltage by means of the resistors R7 and R8.

If the node CKV_COM of the subtractor 910 has an output voltage greater than the positive (+) reference voltage or smaller than the negative (−) reference voltage set by the signal detector 920, the output terminal CKV_OUT of the signal detector 920 outputs a high level signal. The positive (+) reference voltage may be +1 V, and the negative (−) reference voltage may be −1 V. For example, if the first gate clock signal CKV1 is greater than the second gate clock signal CKV2, a voltage of +1 V or greater is detected. By contrast, if the second gate clock signal CKV2 is greater than the first gate clock signal CKV1, a voltage of −1 V or less is detected by the signal detector 920.

High level signal output to the output terminal CKV_OUT of the signal detector 920 indicates that a failure has occurred to one block of the liquid crystal panel 300. In this case, the high level signal is transmitted to the timing controller 600 to turn it off, thereby prohibiting an image from being displayed on the liquid crystal panel 300. By contrast, if a low level signal is output to the output terminal CKV_OUT of the signal detector 920, it is transmitted to the timing controller 600 to make it operate normally, thereby enabling an image to be displayed on the liquid crystal panel 300.

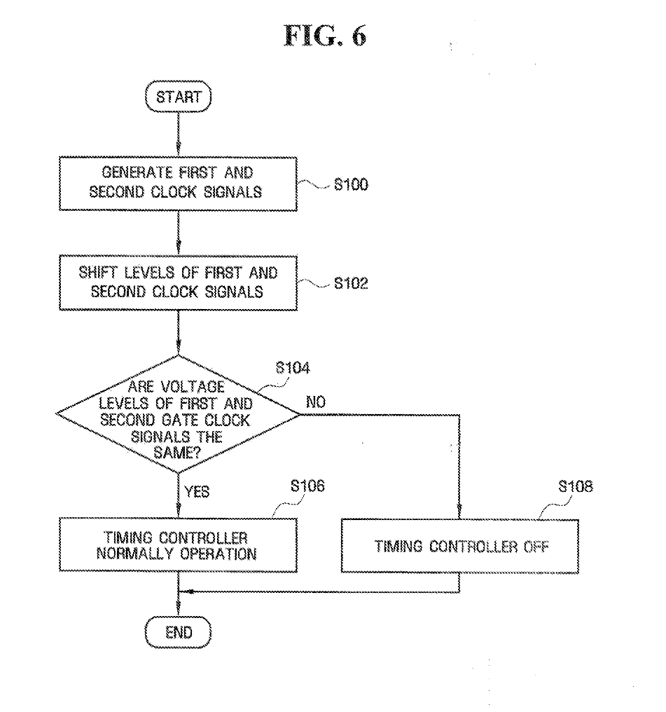

FIG. 6 is a flow chart showing an operation of the signal comparator 900 according to an exemplary embodiment of the present invention. As shown in FIG. 6, in operation S100, the voltage generator 700 generates the first and second gate clock signals CKV1 and CKV2, being a combination of the gate-on voltage Von and the gate-off voltage Voff, and feeds the gate clock signals to the gate lines G1-Gn.

In operation S102, voltage levels of the first and second gate clock signals CKV1 and CKV2 generated by the voltage generator 700 are converted into predetermined levels by a level shifter (not shown) so as to serve as the gate-on voltage Von and the gate-off voltage Voff.

In operation S104, the first and second gate clock signals CKV1 and CKV2 are compared with each other to determine whether the voltage levels thereof are equal or not. If a comparison result shows that the voltage levels of the first and second gate clock signals CKV1 and CKV2 are the same, a low level signal is output to the output terminal CKV_OUT of the signal comparator 900 indicating that the liquid crystal panel 300 operates normally, and the low level signal is transmitted to the timing controller 600 to allow the timing controller 600 to operate normally, thereby enabling an image to be displayed on the liquid crystal panel 300 in operation S106.

If the voltage levels of the first and second gate clock signals CKV1 and CKV2 are not equal, however, a high level signal is output to the output terminal CKV_OUT of the signal comparator 920 indicating that a failure has occurred to one block of the liquid crystal panel 300, and the high level signal is transmitted to the timing controller 600 to turn off the timing controller 600 to prohibit an image from being displayed on the liquid crystal panel 300, in operation S108.

As described above, according to an exemplary embodiment of the present invention, gate clock signals respectively applied to gate drivers disposed at left and right sides of a liquid crystal panel are compared with each other, and a timing controller is turned on or off according to a comparison result, thereby easily detecting a failure occurring in the liquid crystal panel.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described embodiments have been provided only in a descriptive sense and will not be construed as placing any limitation on the scope of the invention.

What is claimed is:

1. A driving apparatus for a display comprising:
a voltage generator generating first and second ate clock signals that are a combination of a gate-on signal and a gate-off signal, wherein the first and second gate clock signals control a turn-on/off condition of a gate line, and
a signal comparator comparing the first gate clock signal and the second gate clock signal with each other and turning a timing controller for the display on or off according to a comparison result.

2. The driving apparatus for a display of claim 1, wherein the signal comparator determines whether a difference between the first gate clock signal and the second gate clock signal is in a range between a first reference voltage and a second reference voltage.

3. The driving apparatus for a display of claim 2, wherein the second reference voltage is a negative polarity voltage.

4. The driving apparatus for a display of claim 2, wherein the second reference voltage is a negative polarity voltage.

5. The driving apparatus for a display of claim 1, wherein the signal comparator includes:
a subtractor comparing voltage levels of first gate clock signal and the second gate clock signal with each other and outputting a difference therebetween; and
a signal detector receiving an output signal of the subtractor and, if the output signal is greater than the first reference voltage or smaller than the second reference voltage, outputting a high level signal to turn off the timing controller.

6. A driving apparatus for a display comprising:
a voltage generator generating first and second gate clock signals that are a combination of a gate-on signal and a gate-off signal, wherein the first and second gate clock signals control a turn-on/off condition of a gate line; and
a signal comparator including a first amplifier amplifying and outputting a difference between the first gate clock signal and the second gate clock signal, a second amplifier amplifying and outputting a difference between an output signal of the first amplifier and the gate-off signal, and a third amplifier amplifying and outputting a difference between an output signal of the first amplifier and a driving voltage.

7. The driving apparatus for a display of claim 6, wherein the first amplifier includes first and second voltage dividers dropping a voltage level of the first and second gate clock signals, respectively.

8. The driving apparatus for a display of claim 6, wherein the second amplifier includes a third voltage divider dropping a voltage level of the gate-off signal.

9. The driving apparatus for a display of claim 6, wherein the third amplifier includes a fourth voltage divider dropping the driving voltage.

10. The driving apparatus for a display of claim 7, wherein the first and second voltage dividers are resistor networks.

11. The driving apparatus for a display of claim 8, wherein the third voltage divider is a resistor network.

12. The driving apparatus for a display of claim 9, wherein the fourth voltage divider is a resistor network.

13. The driving apparatus for a display of claim 7, wherein one end of the first voltage divider is connected to an inverting input terminal of the second amplifier.

14. The driving apparatus for a display of claim 6, wherein the output terminal of the second amplifier is connected to an output terminal of the third amplifier.

15. A liquid crystal display comprising:
a liquid crystal panel including a plurality of unit pixels having a respective plurality of switching devices arranged in a matrix, a plurality of gate lines and data lines connected to the plurality of switching devices and transmitting data and gate voltages, the gate lines extending to sides of the liquid crystal panel, and first and second gate drivers connected to the plurality of gate lines at both sides of the liquid crystal panel to which the plurality of gate lines extend;
a timing controller receiving externally supplied image data and outputting data suitable for operating the liquid crystal panel and generating gate and data control signals for driving the first and second gate drivers and a data driver;
a voltage generator generating first and second gate clock signals that are a combination of a gate-on signal and a gate-off signals, wherein the first and second gate clock signals control a turn-on/off condition of a gate line; and
a signal comparator comparing the first gate clock signal and the second gate clock signal with each other, providing the first gate clock signal and the second gate clock to the first and second gate drivers, respectively, if the first gate clock signal and the second gate clock are the same, and turning off the timing controller if the first gate clock signal and the second gate clock signal are not the same; wherein
the data driver applies a data voltage to the plurality of data lines.

16. The liquid crystal display of claim 15, wherein the signal comparator determines whether a difference between the first gate clock signal and the second gate clock signal is in a range between a first reference voltage and a second reference voltage.

17. The liquid crystal display of claim 16, wherein the first reference voltage is a positive polarity voltage.

18. The liquid crystal display of claim 16, wherein the second reference voltage is a negative polarity voltage.

19. The liquid crystal display of claim 15, wherein the signal comparator comprises:
a subtractor comparing voltage levels of the first gate clock signal and the second gate clock signal with each other, and outputting a difference therebetween; and
a signal detector receiving an output signal of the subtractor and if the output signal is greater than the first reference voltage or smaller than the second reference voltage, outputting a high level signal to turn off the timing controller.

20. The liquid crystal display of claim 15, wherein the switching devices are made of amorphous silicon.

21. The liquid crystal display of claim 15, wherein the first and second gate drivers and the switching devices are formed on a same substrate.

22. The liquid crystal display of claim 15, wherein the first and second gate drivers are formed at the same time that the switching devices are formed.
